(19) United States
(12) Patent Application Publication
(10) Pub. No.: US 2010/0321558 A1
(43) Pub. Date: Dec. 23, 2010

(54) APPARATUS AND METHOD FOR DETECTING SPATIAL MOVEMENT OF OBJECT

(75) Inventors: CHI-WEI CHIU, Tu-Cheng (TW); PING-HAN KU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/650,797

(22) Filed: Dec. 31, 2009

(30) Foreign Application Priority Data
Jun. 19, 2009 (CN) 200910303476.1

(51) Int. Cl. G06T 7/00; H04N 5/225

(52) U.S. Cl. 348/360; 382/103; 382/106; 348/E05.024

(57) ABSTRACT

An apparatus for detecting spatial movement of an object, includes a rotatable light emitting diode, first and second camera modules, and an image processor. The light emitting diode is configured for emitting light to the object. The first and second camera modules are arranged on opposite sides of the light emitting diode and configured for capturing the light reflected by the object, thus respectively forming a first image signal and a second image signal associated with the object. The image processor is configured for processing the first and second image signals and analyzing spatial position of the object relative to the first and second camera modules based on the first and second image signals, thereby determining spatial movement of the object.

### BACKGROUND

1. Technical Field

The present disclosure relates to apparatuses and methods for detecting movements of objects, and particularly, to an apparatus and a method for detecting spatial (3-D) movement as opposed to linear (1-D) or planar (2-D) movement of an object.

2. Description of Related Art

Object movement detection is proposed to be applied in a variety of fields, such as operations of three dimensional (3-D) games and image captures. With the help of object movement detection, real-time operations of 3-D games and image capture can be achieved.

A method used for detecting movement of an object, includes steps of sending infrared rays to the object, receiving the infrared rays reflected by the object, and obtaining the movement of the object based on elapsed time between sending and receiving of the infrared rays and the quantities of the infrared rays received.

However, with the above-described method, only movement along one axis or two axes, i.e., only linear or planar movement may be detected.

What is needed, therefore, is an apparatus and a method for detecting spatial movement of an object, which can overcome the above shortcomings.

### BRIEF DESCRIPTION OF THE DRAWINGS

Many aspects of the present apparatus and method can be better understood with reference to the following drawings. The components in the drawings are not necessarily drawn to scale, the emphasis instead being placed upon clearly illustrating the principles of the present apparatus and method. Moreover, in the drawings, like reference numerals designate corresponding parts throughout the several views.

FIG. 1 is a schematic view of an apparatus for detecting spatial movement of an object in accordance with an embodiment.

FIG. 2 shows a spatial coordinate system in calculating coordinates of an object along XYZ axes.

FIG. 3 shows the coordinates along the X and Z axes of FIG. 2.

FIG. 4 shows the coordinates along the Y and Z axes of FIG. 2.

### DETAILED DESCRIPTION OF THE EMBODIMENTS

Embodiments of the present apparatus and method will now be described in detail below and with reference to the drawings.

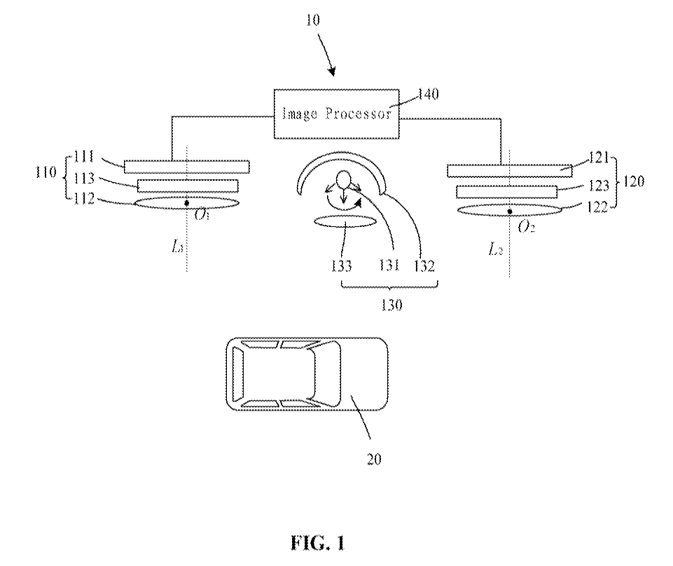

Referring to FIG. 1, an exemplary apparatus 10 configured for detecting spatial movement of an object 20, is shown. The apparatus 10 includes a first camera module 110, a second camera module 120, a light source 130 and an image processor 140.

The first camera module 110 includes a first image sensor 111, a first lens 112 and a first filter 113 disposed between the first image sensor 111 and the first lens 112. The second camera module 120 includes a second image sensor 121, a second lens 122 and a second filter 123 disposed between the second image sensor 121 and the second lens 122. The first lens 112 defines an optical center O₁, and an optical axis L₁. The second lens 122 defines an optical center O₁, and an optical axis L₁. The first filter 113 and the second filter 123 are configured for substantially blocking transmission of light having a wavelength different from that of the light emitted from the light emitting diode 130, and thus only allow the light emitted from the light source 130 to enter therein. The first image sensor 111 and the second image sensor 121 can be CCD or CMOS. In the present embodiment, the first image sensor 111 and the second image sensor 121 are disposed at a same level, and the first and second image sensors 111, 121 are spaced from the respective first and second lenses 112, 122 a same distance f. The “f” can be the focal length of each of the first and second lenses 112, 122.

The light source 130 is located between the first camera module 110 and the second camera module 120, and the first camera module 110 and the second camera module 120 each are spaced from the light source 130 a same distance d. The light source 130 includes a rotatable laser diode 131, a reflecting mirror 132 facing the laser diode 131, and a light adjusting lens 133 disposed at an opposite side of the laser diode 131 relative to the reflecting mirror 132. The light adjusting lens 133 can be a converging lens or a collimating lens. The reflecting mirror 132 has a curved reflecting surface facing the laser diode 131. The laser diode 131 is disposed between the reflecting mirror 132 and the light adjusting lens 133. The laser diode 131 can be driven to rotate by a motor (not shown). The laser beam can directly transmit through the light adjusting lens 133 and then project on the object 20, or can be reflected by the reflecting mirror 132 and then transmit through the light adjusting lens 133 and finally project onto the object 20.

The laser beam forms a laser point on the object 20. The rotatable laser diode 131 allows the laser point to scan the object 20, thus enlarging the lighting area on the object 20. The first camera module 110 and the second camera module 120 can capture the laser point at a same time, and then respectively form a first image signal and a second image signal associated with the object 20.

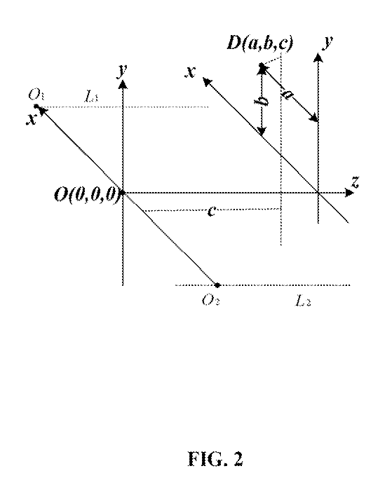

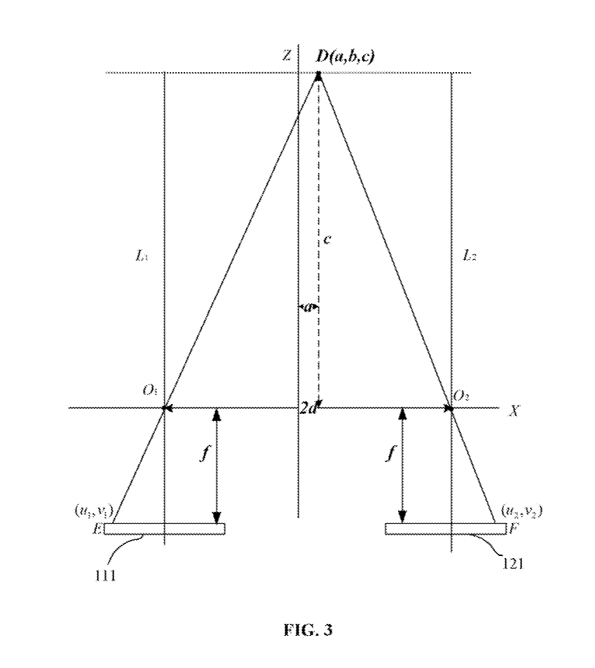

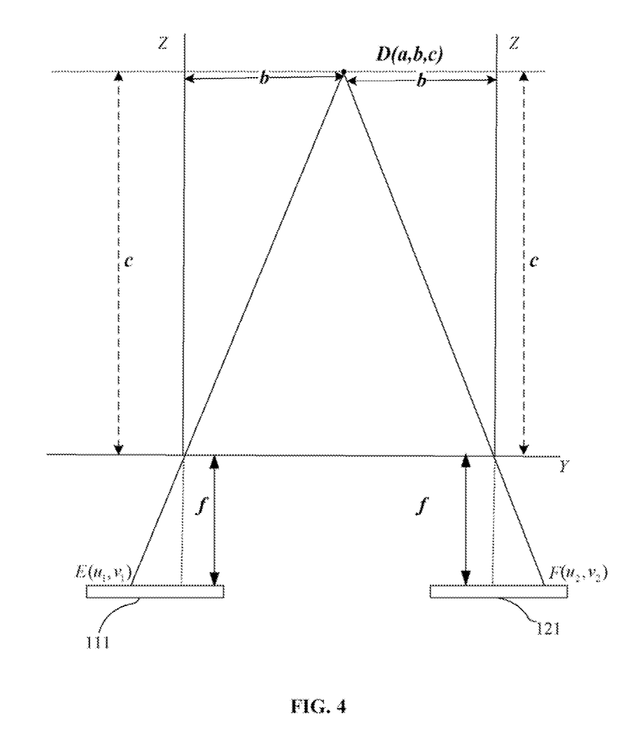

Referring to FIG. 2, in the present embodiment, the laser point D is projected onto the object 20. The object 20 is located at a position with spatial coordinates (a, b, c). The spatial coordinate system is defined with X axis, Y axis, and Z axis. X axis is oriented along the O₁O₂ line. Y axis and Z axis are perpendicular to the X axis and are perpendicular to each other. The center O of the O₁O₂ segment represents the origin of the coordinates, wherein “a” represents an X axis coordinate, “b” represents a Y axis coordinate, and “c” represents a Z axis coordinate. Images E and F of the initial laser point D are captured by the first and second image sensor 111, 121, respectively, with the image E located at position (u₁,v₁) on the first image sensor 111, and the image F located at position (u₂,v₂) on the second image sensor 121 (see FIGS. 3 and 4). The image processor 140 can read the positions (u₁,v₁) and (u₂,v₂).

Referring to FIG. 3, in the XZ planar coordinate system, according to the principle of similar triangles, it can be concluded that

$$\frac{{u}_{1}}{f} = \frac{d + a }{c} ,$$

and

$$\frac{{u}_{2}}{f} = \frac{d - a}{c} .$$

Referring to FIG. 4, in the YZ planar coordinate system, according to the principle of similar triangles, it can be concluded that

$$\frac{{v}_{1}}{f} = \frac{b}{c} ,$$

and

$$\frac{{v}_{2}}{f} = \frac{b}{c} .$$

In this way, the coordinates (a, b, c) can be determined based on u₁, u₂, v₁, v₂, f and d, and thus the image processor 140 can obtain the coordinates (a, b, c) of the laser point D.

According to the above-described method, the image processor 140 can continuously determine coordinates of the laser point D. In this way, the spatial movement of the object 20 can be determined.

It is understood that the laser diode 131 can be replaced by other light emitting diodes.

It is understood that the above-described embodiments are intended to illustrate rather than limit the embodiment. Variations may be made to the embodiments and methods without departing from the spirit of the disclosure. Accordingly, it is appropriate that the appended claims be construed broadly and in a manner consistent with the scope of the embodiment.

What is claimed is:

1. An apparatus for detecting spatial movement of an object, comprising:
a rotatable light emitting diode configured for emitting light to the object;
first and second camera modules arranged on opposite sides of the light emitting diode and configured for capturing the light reflected by the object, thus respectively forming a first image signal and a second image signal associated with the object; and
an image processor for processing the first and second image signals and analyzing spatial position of the object relative to the first and second camera modules based on the first and second image signals, thereby determining spatial movement of the object.

2. The apparatus as described in claim 1, wherein the light emitting diode is a laser diode configured for emitting a laser beam to form a laser point on the object.

3. The apparatus as described in claim 1, wherein the first and second camera modules each includes an image sensor, a lens, and a filter disposed between the image sensor and the lens, the filter configured for substantially blocking transmission of light having a wavelength different from that of the light emitted from the light emitting diode.

4. The apparatus as described in claim 3, wherein the image sensors are spaced a same distance from the respective lenses.

5. The apparatus as described in claim 1, further comprising a reflecting mirror facing the light emitting diode and a light adjusting lens disposed at an opposite side of the light emitting diode relative to the reflecting mirror.

6. The apparatus as described in claim 5, wherein the reflecting mirror includes a curved reflecting surface.

7. The apparatus as described in claim 5, wherein the light adjusting lens is a converging lens or a collimating lens.

8. An apparatus for detecting spatial movement of an object, comprising:
a rotatable laser diode configured for projecting laser point on the object;
first and second camera modules arranged on opposite sides of the laser diode and spaced a same distance from the laser diode, the first and second camera modules configured for capturing an image of the laser point reflected by the object, thus respectively forming a first image signal and a second image signal associated with the object; and
an image processor for processing the first and second image signals and analyzing spatial position of the object relative to the first and second camera modules based on the first and second image signals, thereby determining spatial movement of the object.

9. A method for detecting spatial movement of an object, comprising steps of:
providing a rotatable light emitting diode for emitting light to the object;
forming image signals associated with the object using a first camera module and a second camera module; and
processing the image signals and analyzing spatial position of the object relative to the first and second camera modules based on the image signals, thereby determining spatial movement of the object.

10. The method as described in claim 9, wherein the light emitting diode is a laser diode configured for emitting a laser beam to form a laser point on the object.

11. The method as described in claim 9, wherein the first and second camera modules each includes an image sensor, a lens, and a filter disposed between the image sensor and the lens, the filter configured for substantially blocking transmission of light having a wavelength different from that of the light emitted from the light emitting diode.

12. The method as described in claim 11, wherein the image sensors are spaced a same distance from the respective lenses.
